(19) United States
(12) Patent Application Publication
(10) Pub. No.: US 2008/0284159 A1
(43) Pub. Date: Nov. 20, 2008

(54) Pipeline Coupling with a Sealing Ring, and Pipeline System for the Delivery of Thick Matter

(75) Inventor: Dietmar Krehl, Dortmund (DE)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: SCHWING GMBH, Herne (DE)

(21) Appl. No.: 12/092,147

(22) PCT Filed: Oct. 5, 2006
(86) PCT No.: PCT/EP06/09658

§ 371 Date: Jun. 24, 2008

(30) Foreign Application Priority Data
Nov. 3, 2005 (DE) 10 2005 052 517.2

(51) Int. Cl. F16L 17/06

(52) U.S. Cl. 285/112

(57) ABSTRACT

Pipeline coupling (6) for connecting individual pipeline sections (51, 52), and pipeline system, wherein individual pipeline sections (51, 52) are clamped together at their end faces by pipe-clamp-like split couplings, and a sealing ring (10) is arranged inside the split coupling part (8), said sealing ring (10) having at least one pressure chamber (12) and at least two spaced-apart sealing surfaces (11) which, under the delivery pressure of the medium to be delivered, bear in a sealing manner against the outer circumference of the respective pipeline sections (51, 52), and wherein the sealing ring (10) furthermore has an encircling distance web (13) which points radially inwards and extends between the end faces of the clamped pipeline sections (51, 52), wherein at least one connecting passage which is permanently effective under delivery pressure is provided in the pipeline coupling (6) between the interior of the pipeline system and the pressure chamber (12) in the sealing ring (10), preferably by recesses (15) in the distance web (13).

The present invention concerns a pipeline coupling for connecting individual pipe sections to a pipeline system for pressurized delivery of thick matter in accordance with the generic term of claim 1 and a pipeline system for pressurized delivery of thick matter in accordance with the generic term of claim 10.

During the conveying of thick matter, for example concrete, mortar and the like, height differences are overcome by means of so-called conveying systems, with which the thick matter to be conveyed is carried through a pressure line or a pipeline system to the desired point of delivery.

The delivery pressure or delivery volume flow is generated here by a thick matter pump.

Such thick matter pumps, especially concrete pumps, usually have two reciprocating delivery cylinders, which, through the reciprocating delivery piston, alternately draw concrete in from a storage vessel and then force it into the pipeline system.

The result is a flow delivered under pulsating delivery pressures.

A common design principle of such conveying systems is a combination of the pipeline system with an articulated and/or telescopic mast, which is installed on a truck, for example.

Of course, such a conveying system may also be stationary in design or as set up as manipulators.

If such a conveying system is installed on a truck, the latter is secured on-site against tipping over.

Only then can the individual articulated mast sections of the articulated mast can be unfolded or deployed and the conveying system started up.

The movement of the articulated mast sections is controlled in a known manner, for example, by means of hydraulic cylinders.

The thick matter pump then conveys the externally provided thick matter through a pipeline system, which is arranged along the articulated mast sections, to the desired point of delivery, where the thick matter, for example, exits the pipeline system via a trunk-like hose extension.

The height differences to be surmounted are considerable and can amount to 50 m and more, a fact which necessitates, however, a high delivery pressure.

Of course, such conveying systems can also be used to overcome horizontal distances, e.g. in hard-to-travel or inaccessible areas.

The pipeline system for conveying the thick matter is fed along the articulated mast sections, partly on the outside and partly on the inside.

It consists of individual pipe sections, which are connected or clamped to each other by means of pipeline couplings.

The pipeline couplings themselves are sealed with sealing rings to prevent unwanted escape of the thick matter.

The design must ensure that the individual pipe sections have restricted mobility relative to each other during folding and unfolding of the articulated mast.

For this reason, the mounting of the individual pipe sections inside the pipeline couplings has at least axial play, e.g. in the order of magnitude of 2-3 mm.

In the region of the articulated mast joints, provision must also be made for adjacent pipe sections to be rotatable.

A not insignificant problem results also from the fact that the delivery volume flow of the thick matter exerts, due to friction on the inner walls of the pipeline system, an axial force on the individual pipe sections, such that adjacent pipe sections are forced apart at the pipeline couplings concerned.

At bends and elbows in the pipeline system, additional forces act on the pipe sections concerned due to the deflection of the delivery volume flow.

For example, a pipeline coupling with a nominal diameter of 125 mm under a delivery pressure of 50 bar can experience a maximum force of 61.36 kN, said force driving the interconnected pipe sections apart.

This is exacerbated by the fact that the articulated mast is moved or displaced during the conveying operation if the delivery point for the thick matter needs to be changed. In this regard, the forces resulting from the delivery volume flow and from the controlling movement of the articulated mast sections act on the pipeline system, sometimes in different directions, such that the connected piping sections experience axial and/or radial displacement, bending and/or twisting relative to each other.

As already described, the mounting for the individual pipe sections therefore allows for play in the pipeline couplings.

This play between the individual pipe sections primarily facilitates axial displaceability of the individual pipe sections, as well as slight bending, radial displacement and/or twisting.

The pipeline couplings have to be sealed with sealing rings to prevent undesirable escape of the thick matter.

For this, it is common practice to use a circular, so-called flange sealing ring, into which the two end faces of the pipe sections to be connected are inserted, as it were, from both sides, before they are clamped to each other, e.g., by means of a split coupling part.

Sealing is effected via sealing lips or surfaces that which make contact with the outer circumference of the pipeline sections concerned.

For the purpose of boosting the bearing pressure exerted by the sealing lips, the flange sealing ring or the sealing ring is provided with an internal pressure chamber, as a result of which the sealing effect is boosted as the delivery pressure rises.

This is an example of a design with a self-boosting sealing effect.

During assembly of the individual pipe sections, for example during first assembly, the end faces of the pipe sections to be connected are typically placed together so as to be flush, i.e. abutting, and are connected or clamped to each other by means of a pipeline coupling, for example a split coupling.

During delivery mode, the play between the individual pipe sections causes the various pipe sections to be pressed apart at the pipeline couplings by the amount of play for which provision has been made, with the total displacement being cumulative and amounting to 20-30 mm and even more.

This may lead to substantial problems at the bearings of the pipeline system. For the purpose of avoiding these problems, a flange sealing ring that has a distance web in the form of an interior lip is normally used during assembly, with the distance web setting the play for the pipe sections to be connected to the maximum possible distance.

The distance web introduced between the end faces of the various pipe sections, however, creates the problem that it is pressed radially outward under the delivery pressure of the delivery volume flow, bulging as it does so, and may seal the gap between the end faces of the pipe sections.

As a result, the internal pressure chamber of the sealing ring remains pressure-free, such that the sealing lips bear against the outer circumference of the pipe sections concerned, without the necessary sealing-force boost.

Controlled sealing is thus no longer possible.

If the conveyed thick matter penetrates the gap in one place, e.g. such that sections of the distance web are pressed radially outward from the gap or are damaged by the said relative movement of the various pipe sections, the bearing pressure of the sealing lips is possibly too low, with the result that the thick matter escapes undesirably from the pipeline coupling.

The object of the invention is to provide a pipeline coupling or a pipeline system ready whose tightness is permanently ensured in the operating state.

The inventive solution is furthermore intended to be economical and not to disproportionately increase manufacturing or assembly outlay.

The object is achieved in accordance with the invention by the features of the characterizing part of claim 1 and by the features of the characterizing part of claim 10, with expedient embodiments characterized by the features of the respective subclaims.

A connecting channel that is permanently effective in the sealing ring between the interior of the pipeline system or the delivery line and the pressure chamber ensures that, in any operating state, i.e. as soon as delivery pressure is built up inside the pipeline system, the pressure chamber in the sealing ring becomes pressurized.

This ensures that controlled sealing occurs via the mostly radially effective sealing surfaces of the sealing rings in any operating state, since this pressurization causes the sealing lips or surfaces to reliably make sealing contact with the outer circumference of the associated pipe sections, and more precisely under operating pressure as well. The tightness of the pipeline coupling and/or the pipeline system is thus ensured for all operating states, with the necessary play between the clamped pipe sections remaining unimpaired at the same time.

Several connecting channels effective in parallel are additionally possible.

A further advantage is that oscillation suppression and noise suppression of the pipe sections clamped to each other are an optimum at any operating point.

The connecting channel and/or the connecting channels furthermore effectively pre-vents local squeezing of the distance web out of the gap between the end faces of the pipe sections, such that the distance web maintains its spacing function in any operating state.

In an advantageous and not obvious embodiment, the connecting channel or the connecting channels are themselves arranged in the sealing ring.

It has transpired that the soft-elastic material of the sealing ring is thoroughly suitable for providing a permanently effective connection between the inside of the pipeline system and the pressure chamber of the sealing ring.

Since the connecting channels can be created directly during the sealing ring production process, this embodiment proves to be extremely economical.

In contrast, much higher costs are associated with the most technically obvious variant, namely the introduction of connecting channels, for example in the form of grooves, into the ends of the pipe sections concerned.

It proves to be particularly advantageous to arrange the connecting channel in the form of a radially outward extending recess in the distance web of the sealing ring, as a result of which a direct connection is formed between the inside of the pipeline system and the pressure chamber of the sealing ring.

Due to contamination or the aforementioned play between clamped pipe sections, it proves to be particularly advantageous to provide several recesses distributed over the circumference in the distance web of the sealing ring, for example five recesses that are evenly incorporated in a circumference angle of 72° to each other in the distance web.

It has further transpired that a semi-circular shape seems to be ideal, with the transitions into the recesses being formed without a bend, i.e. are tangent-continuous.

If several recesses are provided, these can have the same shapes and dimensions, but there is no technical necessity for this.

The radial depth of the recess is to be chosen such that a connecting channel or several connecting channels is/are reliably provided between the inside of the pipeline system and the pressure chamber of the sealing ring during delivery.

In order that sufficient mechanical stability of the sealing ring may be ensured, especially of the remaining distance web sections, the radial depth of the recess or the recesses should not quite correspond to the web height, such that residual web is still present at the lowest point of the recess.

An order of magnitude of ⅔ to ¾ of the overall height of the distance web has proved to be a useful value for the radial depth of the recesses, a fact which corresponds to a percentage value of approximately 60-80% of the overall height of the distance web.

For the reasons of economy already stated, it appears reasonable to manufacture the sealing ring in one-piece.

This keeps down manufacturing and storage costs.

It also minimizes assembly effort.

The sealing ring is advantageously formed from soft-elastic material, preferably from a material similar to natural rubber, for example from a rubber-based material, an elastomer material or a silicone material.

For easier assembly, the distance web is centrically arranged in the axial direction of the sealing ring, as a result of which there is no need to allow for an installation position during installation.

The connecting channel or the connecting channels may additionally be formed by recesses extending radially in the distance web.

Furthermore, it is possible to form the distance web such that it differs, i.e. varies, in thickness across its extent, as a result of which connecting channels also inevitably form.

An embodiment is described and explained in more detail in the following on the basis of the figures.

They show in

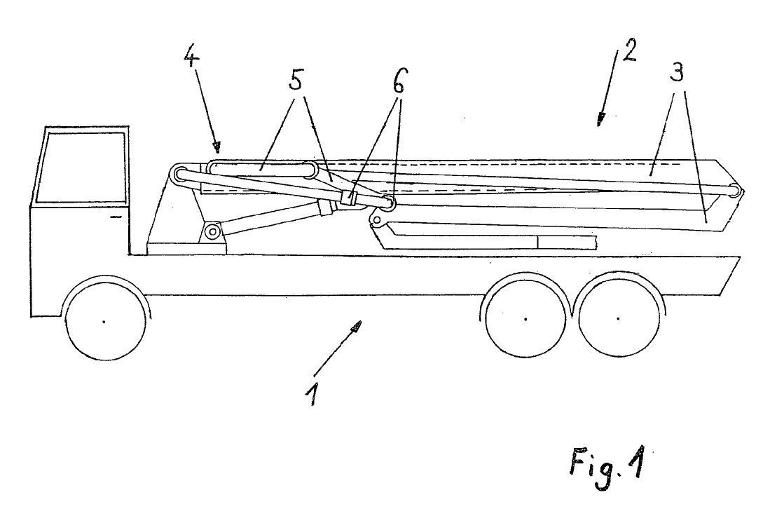

FIG. 1 a truck with an articulated mast for delivering concrete;

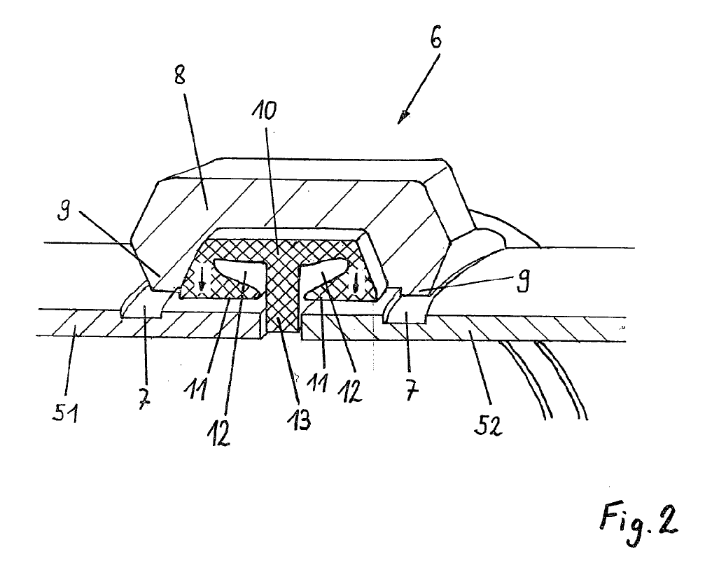

FIG. 2 the connection of two pipe sections by means of a split coupling in accordance with the prior art;

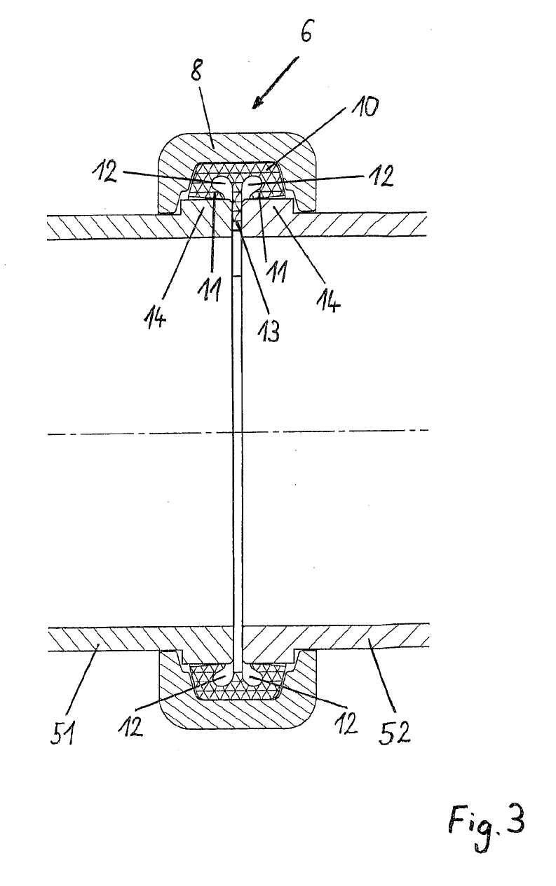

FIG. 3 a cross-sectional view of the connection of two pipe sections by means of a pipeline coupling featuring the inventive connecting channels;

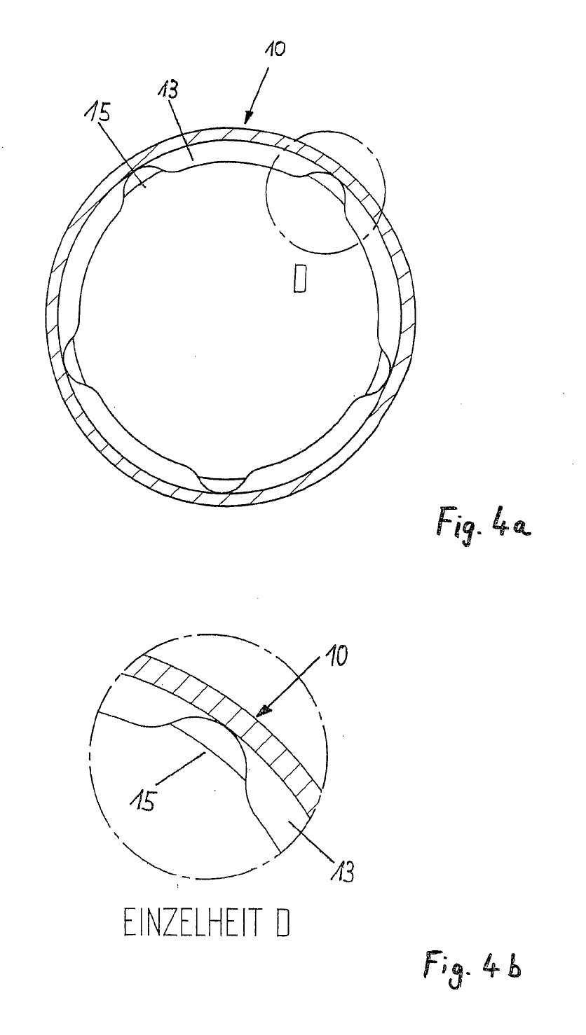

FIG. 4a a sealing ring with recesses in a partial cross-section;

FIG. 4b a detailed illustration of an individual recess of the sealing ring from FIG. 4a;

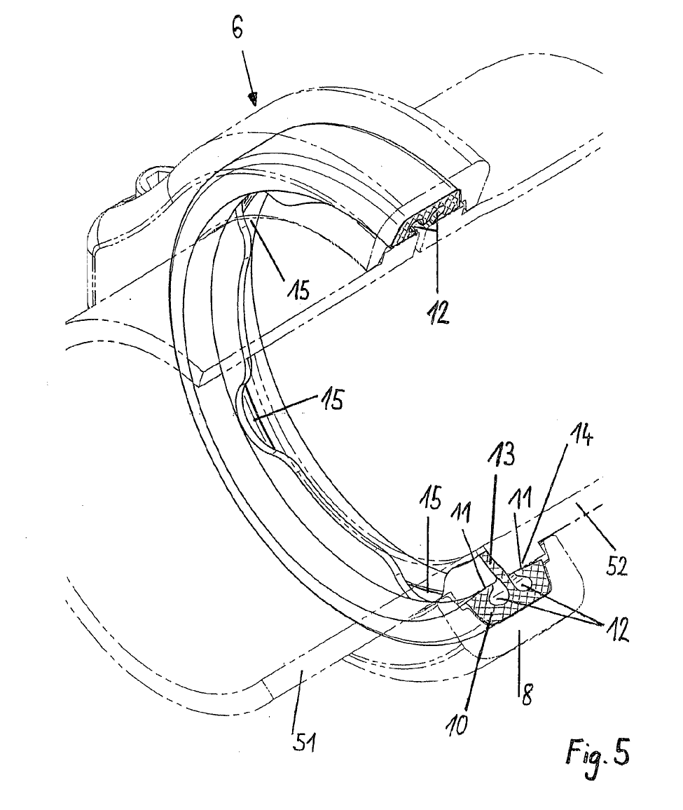

FIG. 5 a perspective view and partial cross-section of a pipeline coupling with the inventive connecting channels;

FIG. 1 shows a truck labelled 1 with an articulated mast 2 that, for conveying thick matter, for example concrete, mortar and the like, swings out such that the thick matter may be delivered, for example, over height differences.

The articulated mast 2 is composed of individual articulated mast sections 3, which are telescopic and/or articulated to each other and may be swung out by hydraulic cylinders hinged at the mast sections.

Along the articulated mast sections 3 and/or partly also inside the articulated mast sections is a delivery line and/or a pipeline system 4 that is composed of individual pipe sections 5.

A common nominal diameter for such a pipeline system for conveying thick matter is, for example, 125 mm.

The individual pipe sections 5 are usually connected or clamped to one another by means of pipe-clamp-like pipeline couplings 6, with a certain amount of play present inside the pipeline couplings 6 such that interconnected pipe sections have the possibility of limited axial displacement, radial displacement, bending and/or twisting relative to each other.

FIG. 2 shows a pipeline coupling 6 that corresponds to the prior art.

The end faces of two neighbouring pipe sections 51 and 52 are usually clamped to each other with a coupling part in the form of a pipe clamp, i.e. with a so-called split coupling.

The outer circumference at the end face areas of the pipe sections 51 and 52 are provided with peripheral grooves 7, into which a pipe-clamp-like split coupling part 8 engages and clamps the two pipe sections 51 and 52 to one another.

Instead of such grooves, the pipe sections are frequently also provided with radially projecting end face flanges, which form shoulders that the split couplings can grip. Typically, the shoulder 9 of the split coupling part 8 is more narrowly designed than the groove 7 at the circumference of the pipe sections 51 or 52 concerned, such that defined axial play occurs between the pipe sections 51 and 52 clamped to one another, a fact which also facilitates slight bending of the two pipe sections toward each other. Furthermore, the guiding of shoulder 9 in groove 7 facilitates twisting of the pipe sections 51 and 52 toward each other.

Inside the split coupling part 8 is a sealing ring 10, which seals the pipeline coupling 6.

The profiled sealing ring 10 has an approximately mushroom-shape cross-section and overlap the ends of the two pipe sections 51 and 52 at their outer circumference.

The sealing lips 11, which here are flat, act together with the outer circumference of the associated pipe sections 51 and 52 to provide a seal.

In order that an optimal sealing effect may be ensured in any operating state, a peripheral pressure chamber 12 is arranged inside the sealing ring 10, said chamber being pressurized during delivery via the gap between the end faces of the pipe sections 51 and 52.

As a result of the pressurization, the sealing surfaces 11 are pressed against the outer circumference of the pipe sections 51 and 52, as shown as by the arrows.

Typically, the end faces of the two pipe sections 51 and 52 are set flush together during assembly.

During delivery, the two pipe sections 51 and 52 are pressed axially apart by the previously described force of the flowing thick matter, such that a gap is formed between the end faces of the pipe sections 51 and 52, by way of which the pressure chamber 12 inside the sealing ring 10 becomes pressurized.

The pressing apart of the two pipe sections 51 and 52 causes problems, however, at the bearing and guiding points of the pipeline system, especially because the play adds up across all couplings, more precisely up to a total of 20 mm to 30 mm depending upon mast length.

Therefore, during assembly, a distance web 13 is incorporated between the two end faces of the pipe sections 51 and 52, said distance web being typically formed so as be one-piece with the sealing ring 10.

Thus, even at the assembly stage, the connection of the two pipe sections 51 and 52 is designed for maximum play, as a result of which the pipeline system can be mounted to the articulated mast without any problems, since the distance webs already include the addition, as it were, of the play of all couplings.

These distance webs however do not seal, but sit between the pipe sections quasi with little play.

As is evident from FIG. 2, however, any deformation of the distance web 13 under the delivery pressure can close the gap between the end faces of the pipe sections clamped to one another and then blocks the entrance to the pressure chamber 12.

During delivery, the distance web may namely be deformed due to the delivery pressure, with said distance web bearing with its radially aligned sides against the end faces of the pipe sections 51 and 52 and closing the gap by sealing.

This leads of necessity to the fact that the actual sealing surfaces 11 effective radially relative to the outer circumference of the pipe sections are no longer 11 effective, as a result of which an uncontrolled sealing condition occurs.

For the rest, aside from the blockade of the distance web 13, which undergoes bulging deformation under the delivery pressure, initial tearing and ultimately tearing off of the same frequently occurs.

Especially, even with allowance for the above-described relative movement of the end faces of the pipe sections inside the pipeline coupling, local damage to the distance web 13 may occur.

Likewise, local pressing of the distance web out of the gap may occur at a point on the circumference.

This is promoted by vibrations and pressure fluctuations in the delivery volume flow. In these cases, thick matter may escape through the gap.

In the absence of the necessary bearing pressure of the sealing surfaces 11 on the outer circumferences of the pipe sections concerned, the thick matter escaping through the gap is, however, not held back effectively, a fact which leads to leakage of the pipeline coupling.

FIG. 3 shows a pipeline coupling 6 in which the peripheral pressure chamber or the peripheral pressure chambers 12 is or are permanently effectively connected to the inside of the pipeline system by a connecting channel, that is to say, also under delivery pressure, when, for example, concrete is delivered in pulsating fashion through the pipeline system.

Usually, concrete delivery takes place under two hydraulic cylinders working in alternation.

In the embodiment shown, the split coupling part 8 overlaps one radial flange 14 each at the end faces of the pipe sections 51 and 52.

Alternatively, the split coupling part 8 could also engage with grooves 7 as shown in FIG. 2.

Inside the split coupling part 8 is the sealing ring 10, which in turn is fixed in position by the split coupling part 8.

For the purpose of sealing, the sealing surfaces 11 of the sealing ring 10 act in tandem with the outer circumference surfaces of the flanges 14.

The sealing ring 10 further comprises a radially-inward-projecting distance web 13 in the form of a lip, which spaces the two end faces of the pipe sections 51 and 52 apart from each other at a defined distance.

Across its circumference, the distance web 13 has at least one, but preferably several recesses 15 in accordance with FIG. 4a.

As shown in the upper section of FIG. 3, the distance web 13 extends across its circumference as far as the recesses 3 into the gap between the pipe sections.

In the lower section of the picture, which shows a cross-section through an recess 15, it may be seen, however, that the inside of the pipeline system is always connected to the pressure chamber 12 of the sealing ring 10 due to the recesses.

On account of the recess 15, the distance web does not reach at this point into the gap between the ends of the pipe sections, as a result of which the pressure chamber 12 formed continuously about the circumference of the pressure ring is capable of being pressurized.

Ideally, several recesses 15 are evenly distributed about the circumference of the distance web 13, as shown in FIG. 4a, for example five recesses spaced apart from each other at a circumferential angle of 72°.

These recesses 15 create a channel-like connection between the interior of the pipeline system and the pressure chamber 12 of the sealing ring 10, said connection being permanently effective i.e. effective in any operating state of the conveying system.

As is evident from the detailed illustration of FIG. 4b, the recesses 15 are approximately formed as semi-circles, with the semi-circle opening, seen radially, on the inside and the semi-circle base, seen radially, on the outside.

The transitions into the recess 15 or from the recess 15 are tangent-constant, i.e., formed so as to be bend-free, as a result of which stress peaks in the material here that might lead to initial tearing, i.e. lead to damage, are effectively prevented.

Of course, other different recess shapes are conceivable.

Also conceivable is a combination of different recess shapes inside a sealing ring.

FIG. 5 clearly shows how such a sealing ring 10 with the described recesses 15 in the installed state provides several connecting channels between the inside of the pipeline system and the peripheral pressure chamber 12, such that, in any operating state, the sealing lips 11 can be pressed against the outer circumference surfaces of the flange 14 and thus the pipeline coupling 6 is reliably sealed to the outside.

The sealing ring 10 is formed from a soft-elastic material, preferably a natural-rubber-like material, for example a rubber-based material, an elastomer material or a silicone material.

Other materials are also conceivable.

In a deviation from the presented embodiment, a sealing ring 10 is also conceivable that has differently arranged sealing surfaces 11, for example in the form of several sealing lips arranged next to each other.

Likewise, several pressure chambers 12 may be provided in the sealing ring 10 and/or the peripheral sealing chamber 12 may be divided into individual pressure chamber sections.

Similarly, the mirror-symmetrical shape of the sealing ring 10 shown in the figures is not necessary from a technical viewpoint.

The shape of the recesses 15 may also deviate from the shape shown in the figures.

1-10. (canceled)

11. Pipeline coupling (6) for connecting individual pipeline sections (5, 51, 52) in a pipeline system (4) for the delivery of media under pressure, especially thick matter such as concrete, mortar and the like, wherein the pipeline sections (5, 51, 52) are connected by their end faces to one another by pipe-clamp-like coupling parts and inside a coupling part (8) is arranged a sealing ring (10), which has at least one pressure chamber (12) and at least two spaced-apart sealing surfaces (11), which under the delivery pressure of the medium to be delivered seal by bearing against the outer circumference of the respective pipeline sections (5, 51, 52), and for which purpose, under delivery pressure, at least one permanently effective connecting channel is provided between the inside of the pipeline sections (5, 51, 52) and the pressure chamber (12) of the sealing ring (10), and wherein the sealing ring (10) furthermore has a peripheral, radially inward pointing distance web (13), that extends between the end faces of the pipeline sections (5, 51, 52) connected to each other by the coupling part, characterized in that in the distance web (13) is arranged at least one radially outward extending recess (15), which forms a connecting channel between the inside of the pipeline sections (5, 51, 52) and the pressure chamber (12) of the sealing ring (10), such that the distance web (13) in the region of this recess (15) does not extend into the gap between the end faces of the pipeline sections (5, 51, 52) connected to each other.

12. Pipeline coupling (6) in accordance with claim 11 characterized in that in the distance web (13) of the sealing ring (10) are arranged five recesses (15) distributed about the circumference that form connecting channels between the inside of the pipeline sections (5, 51, 52) and the pressure chamber (12) of the sealing ring (10).

13. Pipeline coupling (6) in accordance with claim 11 characterized in that the recesses (15) in the distance web (13) are formed so as to be semi-circular and continuous, especially tangent-continuous at the transition points.

14. Pipeline coupling (6) in accordance with claim 13 characterized in that the semi-circle openings of the semi-circular recesses (15), seen radially, are on the inside and the semi-circle base, radially seen, are on the outside.

15. Pipeline coupling (6) in accordance with claim 11 characterized in that the recesses (15) have a radial depth of a maximum of 60% of the total height of the distance web (13), preferably a maximum depth of 80% of the total height of the distance web (13).

16. Pipeline coupling (6) in accordance with claim 11 characterized in that the sealing ring (10) is formed as one piece from an elastic, preferably natural-rubber-like material.

17. Pipeline coupling in accordance with claim 11 characterized in that the distance web (13) is arranged centrally in the axial direction of the sealing ring (10).

18. Pipeline coupling (6) in accordance with claim 11 characterized in that the distance web (13) has a different, varying thickness across its circumference and/or is provided with radially extending, preferably groove-like recesses, as a result of which at least one connecting channel is present between the inside of the pipeline sections (5, 51, 52) and the pressure chamber (12) of the sealing ring (10).

19. Pipeline system (4) for the delivery of media under pressure, especially thick matter such as concrete, mortar and the like, comprising several pipeline sections, with the pipeline sections (5, 51, 52) being connected to each other by pipeline couplings (6) characterized in that at least two pipeline sections (5, 51, 52) are connected to each other by a pipeline coupling (6) in accordance with claim 11.
